(19) United States
(12) Patent Application Publication
(10) Pub. No.: US 2006/0174895 A1
(43) Pub. Date: Aug. 10, 2006

(54) Adjustable orthopedic positioning device and method of use

(75) Inventors: Joe William Ferguson, Collierville, TN (US); Carl M. Stamp, Collierville, TN (US)

Correspondence Address: COATS & BENNETT, PLLC, P O BOX 5, RALEIGH, NC, 27602, US

(73) Assignee: SDGI Holdings

(21) Appl. No.: 11/051,284

(22) Filed: Feb. 4, 2005

(51) Int. Cl. A61G 15/00

(52) U.S. Cl. 128/845

(57) ABSTRACT

An orthopedic device to register and retain an anatomical position. The device includes a plurality of independently deformable members or one or more support members forming a contact area adapted to contact the body and conform to the anatomical position when placed in contact with the body. One or more adjustment members permit alteration of the contact area either to conform to a neutral anatomical position or to set a desired anatomical position. A locking mechanism is included to lock the adjustment members to retain the shape of the contact area after the body is removed from the contact area. The desired anatomical position may be repeatably established by placing the body in contact with the contact area having the retained shape. A reproducible reference datum may be used to replicate the desired skeletal orientation interoperatively.

### BACKGROUND

Orthopedic procedures often require precise anatomical positioning. For instance, certain spinal surgical procedures require a fixed, known positioning of the spinal column. Surgeons often strive to place a patient's anatomy, such as the neck or back in a neutral position (e.g., having an appropriate lordosis or kyphosis) for better access during surgery and/or to place surgical devices or implants. Crude implements such as inflatable pads, saline bags, or rolled-up sections of material are sometimes used in an effort to accomplish this task.

Other diagnostic and pre-operation procedures may also require a known anatomical positioning. Imaging procedures such as X-Ray, CT or MR imaging provide invaluable information and are often used as a reference during surgical procedures. Positioning markers that appear in the resultant images are sometimes used to help identify reference points. However, the position of these markers as well as the position of the patient's anatomy should be repeatably established for maximum reliability. The locating markers are more accurate if the anatomical position is the same as when the images were taken. The relevant anatomy should also be stabilized and near-motionless during imaging process to enhance the resultant image quality.

Further, the relatively recent introduction of motion sparing devices as spinal implants entails a greater degree of positional precision as compared to that needed for fusion technology. Thus, the need for repeatable, accurate anatomical positioning has become even more crucial.

Accordingly, some effort has been made to use a positioning device to capture a desired anatomical position prior to surgery, perhaps during a consultation visit, and then transfer that position to the operating room table for surgery. However, it is often difficult for surgeons to accomplish this feat because of the bulkiness and lack of repeatable accuracy and adjustability found in conventional devices.

### SUMMARY

Embodiments of the present invention are directed to orthopedic positioning devices adapted to capture or register a desired anatomical position. Numerous embodiments are provided, each employing various mechanisms for capturing the desired anatomical position. Embodiments may include a plurality of independently deformable members or one or more support members forming a contact area adapted to contact the body and conform to the anatomical position when placed in contact with the body. One or more adjustment members may be used to permit alteration of the contact area either to conform to a neutral anatomical position or to set a desired anatomical position. A locking mechanism may further be included to lock the adjustment members to retain the shape of the contact area after the body is removed from the contact area.

### BRIEF DESCRIPTION OF THE DRAWINGS

FIG. 1 is a profile view of an adult human showing a curvature of the spine that may be registered using one or more embodiments of the present invention;

FIG. 2 is a schematic illustration of an orthopedic device according to one embodiment of the present invention approximately positioned for registering the head and cervical curvature anatomy of a human subject;

FIG. 3 is a side view of an orthopedic device according to one embodiment of the present invention;

FIG. 4 is a top view of an orthopedic device according to one embodiment of the present invention;

FIG. 5 is a side view of an orthopedic device according to one embodiment of the present invention;

FIG. 6 is a top view of an orthopedic device according to one embodiment of the present invention;

FIG. 7 is a side view of an orthopedic device according to one embodiment of the present invention;

FIG. 8 is a front view of an orthopedic device according to one embodiment of the present invention;

FIG. 9 is a side view of an orthopedic device according to one embodiment of the present invention;

FIG. 10 is a schematic illustration of an orthopedic device according to one embodiment of the present invention approximately positioned for registering the head and cervical curvature anatomy of a human subject;

FIG. 11 is an isometric view of an orthopedic device according to one embodiment of the present invention;

FIG. 12 is a side view of an orthopedic device according to one embodiment of the present invention;

FIG. 13 is an isometric view of an orthopedic device according to one embodiment of the present invention;

FIG. 14 is a side view of an orthopedic device according to one embodiment of the present invention;

FIG. 15 is a section view of an orthopedic device according to one embodiment of the present invention;

FIG. 16 is a side view of an orthopedic device according to one embodiment of the present invention; and

FIG. 17 is an isometric view of an orthopedic device according to one embodiment of the present invention.

### DETAILED DESCRIPTION

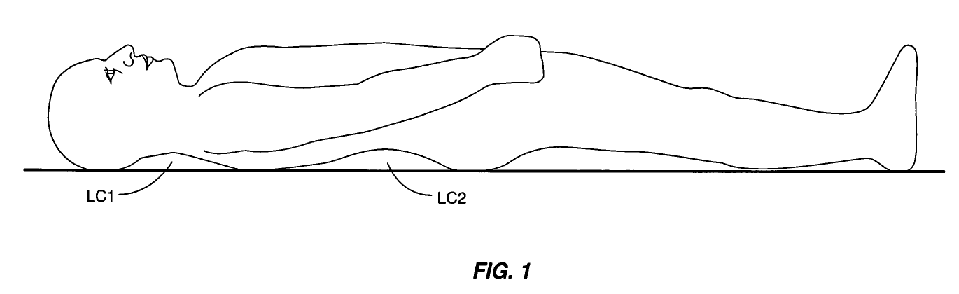

The present invention is directed to embodiments of orthopedic devices and methods adapted to capture and retain a desired anatomical position. As a non-limiting example, the lordotic curvatures designated LC1 (cervical) and LC2 (lumbar) in FIG. 1 may need to be set, determined, and repeatably transferred to various locations, such as an imaging lab or an operating room. For example, a surgeon may want to capture an existing curvature of an otherwise young, healthy patient. Conversely, the surgeon may wish to set a more “normal” curvature for a patient who is experiencing abnormal, possibly degenerative, curvature (lordotic or otherwise) of the spine. This procedure may be performed preoperatively, anywhere from immediately before to days in advance of surgery. Then, the patient may be placed in contact with the device at later times, such as during an operation, to reproduce the same anatomical position.

In any case, the present embodiments and methods of using said embodiments are well suited for establishing and repeatably determining an appropriate vertebral spacing and alignment. The devices disclosed herein may also be suitable for capturing desired skeletal and anatomical positions for other parts of the body, including for example, arms, legs, elbows, and knees. Various embodiments of devices adapted to accomplish these functions will now be described with reference to the Figures where corresponding parts are referenced throughout this description by similar numbers.

### Embodiment 1

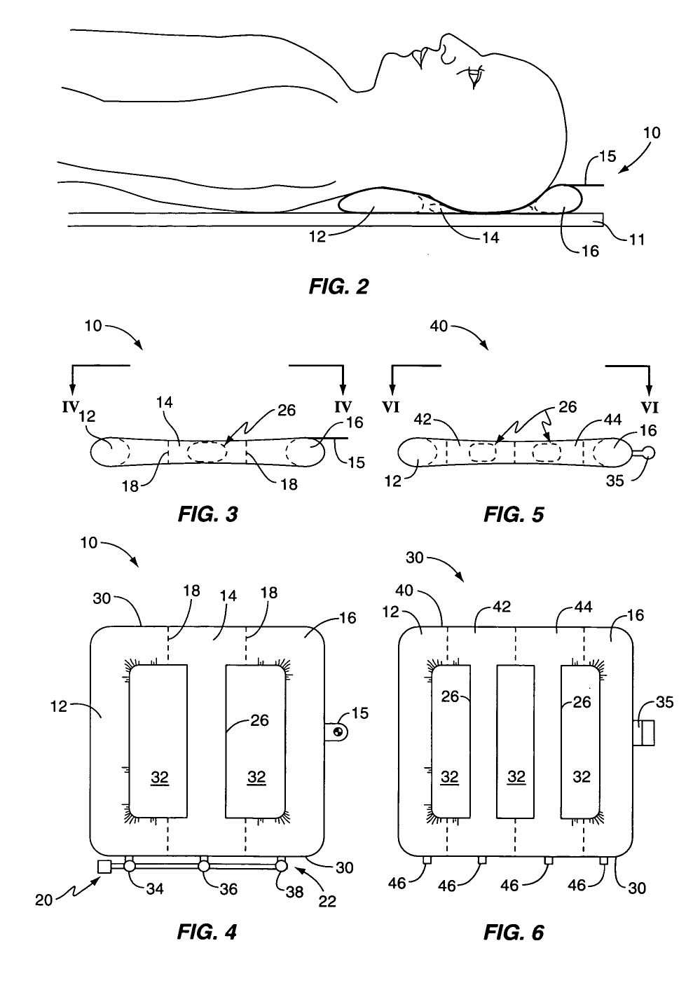

In one embodiment, the orthopedic device is designated generally by the number 10, as shown in FIGS. 2, 3 and 4. FIG. 2 shows a side view of the orthopedic device used in one particular application to capture or establish a desired cervical lordotic curve. The device 10 may be used to position the patient on the operating room table 11 during surgery to get the proper position for accessing and accurately placing instrumentation, surgical devices, or surgical implants. In addition, the device 10 may be used to register a patient's neutral head and/or neck position pre-operatively in the supine or standing position so that the desired anatomical position may be transferred into the operating room or imaging lab for the procedure. Advantageously, this device 10 may be a stand-alone item, an item that attaches to a wall, a bed, an operating room table or similar item. Alternatively, the device 10 may be an integral part of any of these items.

As shown in FIGS. 3 and 4, the orthopedic device 10 is constructed as a multi-chambered support pad with a plurality of individual chambers 12, 14, 16 separated from one another by parting walls or seams 18. The device 10 has a flexible outer skin that is compliant and adapted to conform to a patient's anatomy but may also be a semi-rigid material or material that requires the input or removal of a signal, field, or pulse to become compliant. Each of the plurality of individual chambers 12, 14, 16 is independent of one another and may be separately inflated or filled to achieve a desired shape. Each chamber 12, 14, 16 is inflatable with a filler substance such as a fluid, including gases or liquids. In one embodiment, the device 10 may include a fluid coupling 20 for connection to a liquid or compressed gas source (not shown), such as in an operating room. In one embodiment, the fluid coupling 20 may be coupled to a portable gas source, such as a refillable tank or disposable carbon dioxide cartridges.

The end chambers 12, 16 are disposed at opposite ends of the device 10, which is substantially rectangular as shown, but may also be round, oval, square, triangular, or other polygonal shapes. The end chambers 12, 16 form opposite ends of the device 10. The end chambers 12, 16 are separated from one another by intermediate chamber 14. The sides 30 of the device 10 are formed in part by each of the individual chambers 12, 14, 16. In one embodiment, end chamber 16 is disposed at a superior end of the device 10 while end chamber 12 is disposed at an inferior end. In one embodiment, end chamber 12 has an interior volume that is slightly larger than end chamber 16. In another embodiment, end chambers 12, 16 have substantially similar interior volumes. A central chamber 14 comprises a hammock section 26 that is suspended at opposite sides 30 of the device 10. Two open sections 32 are bounded by the hammock section 26 and one of the end chambers 12, 16.

The device 10 includes a fluid pressure regulating system 22 consisting of individual control valves 34, 36, 38 for controlling the flow of fluid from the fluid coupling 20 to the individual chambers 12, 14, and 16, respectively. The control valves 34, 36, 38 may be actuated to allow pressurized gas or liquid to flow from the fluid source (via coupling 20) into the respective chambers 12, 14, 16. Further, the same control valves 34, 36, 38 may also be actuated to release pressurized gas/liquid from the chambers 12, 14, 16 to the atmosphere or to a scavenging or collection mechanism. In this manner, the control valves 34, 36, 38 may be used to adjust the size, shape, rigidity and compliance of the individual chambers 12, 14, 16. Thus, as shown in FIG. 2, end chamber 12 may be inflated to a greater degree than medial chamber 14 or end chamber 16 to capture or impart a desired cervical lordotic curvature and head position in the subject patient. In a similar manner, the anterior or posterior rotation of a limb or head may be controlled by controlling the inflation of the individual chambers 12, 14, 16. All control valves 34, 36, 38 may then be closed to seal the contents of the chambers and retain the desired anatomical position.

### Embodiment 2

In another embodiment, an orthopedic device similar to that described in Embodiment 1 is designated generally by the number 40, as shown in FIGS. 5 and 6. The device 40 includes the previously described end chambers 12, 16 and sides 30. However, two intermediate chambers 42, 44, each comprising the aforementioned hammock section 26, are incorporated into the device. Consequently, three open sections 32 are formed in the device 40. Naturally, any number of intermediate chambers may be incorporated into the orthopedic devices 10, 40. A corresponding number of hammock sections 26 and open sections 32 will vary as the number of intermediate chambers vary.

Each of the individual chambers 12, 16, 42, 44 of device 40 includes an inlet port 46 that may be used as a one-time fill port or as an inlet-outlet adjustment port. Further, each of the individual chambers 12, 16, 42, 44 may be filled with a common fluid, gas, or liquid or some combination thereof. In one embodiment, the individual chambers 12,16, 42, 44 may be filled, at the time when the patient's anatomy is to be captured or set, with a solidifying fluid such as a quick setting polyurethane or polystyrene foam. Thus, the device may be placed adjacent the patient's anatomy and a suitable amount of the solidifying fluid can be injected into the individual chambers. Once the contents of the chambers 12, 16, 42, 44 harden and cure, the desired anatomy will be advantageously captured. Alternatively, the individual chambers 12, 16, 42, 44 may also be pre-filled or lined with a thermoplastic or thermoplastic elastomer substance, which allows the device 40 to conform to the patient's anatomy when heated to a predetermined temperature, but which also hardens to retain the desired shape once cooled.

In the aforementioned embodiments and in the embodiments described below, a reference datum may be used in conjunction with the orthopedic device 10, 40 to establish the desired anatomical position. The reference datum may then be used during subsequent anatomical re-positioning as a verification that the desired anatomy is in fact replicated. Those skilled in the art will comprehend that a variety of different measuring reference tools may be used. For instance, a linear measurement to a data point or between surfaces may be taken. To that end, a datum feature 15 may be included on the device 10 as shown in FIGS. 2, 3, and 4. A linear measurement between the datum feature 15 and table 11 may be taken and subsequently verified. Alternatively, a probe may be used to mechanically determine the height of the datum feature. Electrical, acoustical, or optical measuring devices may also be used.

Another non-limiting example of a reference feature is an inclinometer 35 as shown in FIGS. 5 and 6. Whereas the datum feature 15 (shown on device 10) may be used to measure linear distances, the inclinometer 35 may be used to determine angular displacements. The inclinometer 35 may be a mechanical, optical, electrical, or fluid filled device. An angular position of a head or limb may therefore be repeatably established by reading the inclinometer 35 output pre-operatively or during an imaging procedure. The patient is then repositioned at a later time (inter-operatively or otherwise) to achieve the same or similar inclinometer 35 output.

### Embodiment 3

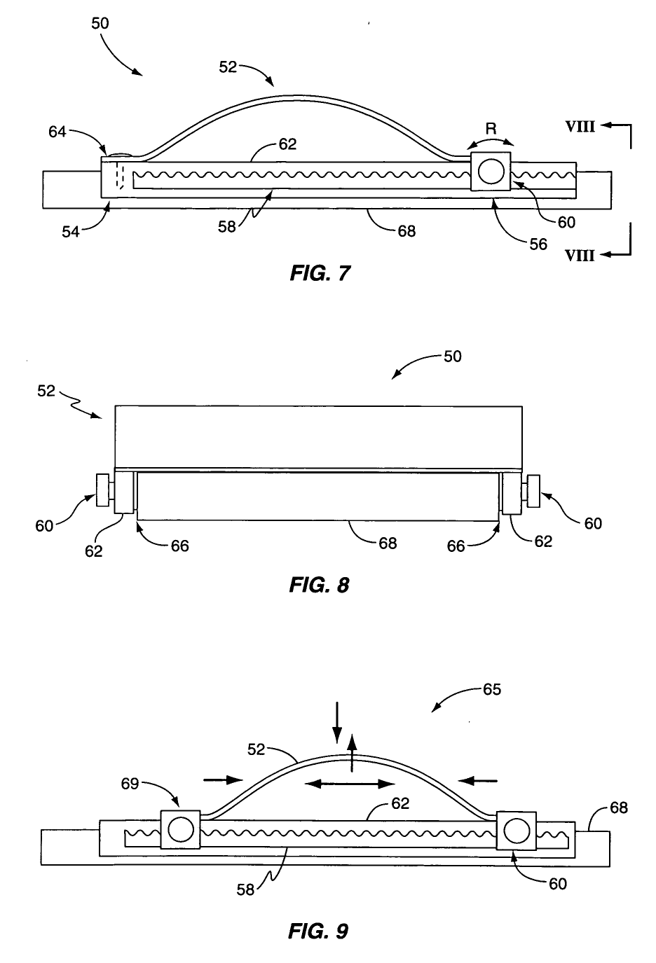

In one embodiment, the orthopedic device is designated generally by the number 50, as shown in FIGS. 7 and 8. The device 50 comprises a flexible sheet 52 anchored at opposite ends 54, 56. The flexible sheet may be constructed of a flexible polymer or other flexible materials, such as a monomer, a metal, or natural material such as leather. The length of the flexible sheet 52 between the ends 54, 56 is generally greater than the straight-line distance between the ends 54, 56 so that the flexible sheet 52 buckles upward in a substantially curved configuration. The curvature of the flexible sheet 52 is adjustable via a rack and pinion gear assembly comprising a substantially stationary rack 58 mounted to a rail 62 and an adjustable pinion gear (not specifically shown) operatively coupled to an adjustment knob 60. The adjustment knob 60 may be rotated in either a clockwise or counter-clockwise direction as indicated by the arrows labeled R. Rotation of the knob 60 causes the knob 60 to move between extended and retracted positions, thereby changing the curvature of the flexible sheet 52.

One end 54 (the fixed end) of the flexible sheet 52 is fixedly attached to the rail 62 using a pin, screw, rivet or other suitable attachment means 64. The opposite end 56 (the free end) of the flexible sheet 52 is coupled, directly or indirectly, to the moveable adjustment knob 60. The adjustment knob 60 and its integral pinion gear move toward or away from the fixed end 54 as the knob 60 is rotated. The adjustment knob 60 may be locked in place to retain the curvature of the flexible sheet 52 using a dedicated locking device (not specifically shown). Alternatively, the knob 60 may be frictionally locked by the presence of an interference between the rack 58 and pinion gears.

As shown in FIG. 8, the device 50 may include two adjustment knobs 60 disposed at opposite sides of the device 50. The two adjustment knobs 60 may be tied together such that rotation of one imparts rotation on the other. Thus, either knob 60 may be used to adjust the position of the entire free end 56 of the flexible sheet 52. Alternatively, the knobs may be tied to separate rack and pinion gear assemblies mounted on separate side rails 62 so as to allow independent adjustment of the sides of the free end 56 of the flexible sheet 52.

The device 50 may also include a set of linear bearings 66 that couple the rail 62 to a base plate 68, which may be mounted onto a table or wall (not shown). Alternatively, the rails 62 may be coupled to a table or wall using the linear bearings 66. Alternatively, the rails 62 may be coupled directly to a table or wall without any linear bearings 66. The bearings 66 allow adjustment of the position of the device 50 as a whole. Thus, the device 50 may be repositioned as needed to accommodate patients having a different height or different anatomy.

### Embodiment 4

In another embodiment, an orthopedic device similar to that described in Embodiment 3 is designated generally by the number 65, as shown in FIG. 9. In contrast to device 40, device 65 includes a flexible sheet 52 having two free ends. That is, both ends of the flexible sheet 52 are coupled to adjustment knobs 60, 69. As above, each adjustment knob 60, 69 includes an integral pinion gear (not explicitly shown) that mates with a rack 58 mounted on a rail 62. Thus, rotation of either adjustment knob 60, 69 results in a change in the shape of the curved, flexible sheet 52. This device 65 may advantageously permit fine adjustment of the curvature and position of the flexible sheet 52 without having to move the entire device 65 relative to the item (e.g., table or wall) on which the device 65 is mounted. However, as with device 50, device 65 may include linear bearings 66 or other adjustment means allowing for gross position adjustment.

### Embodiment 5

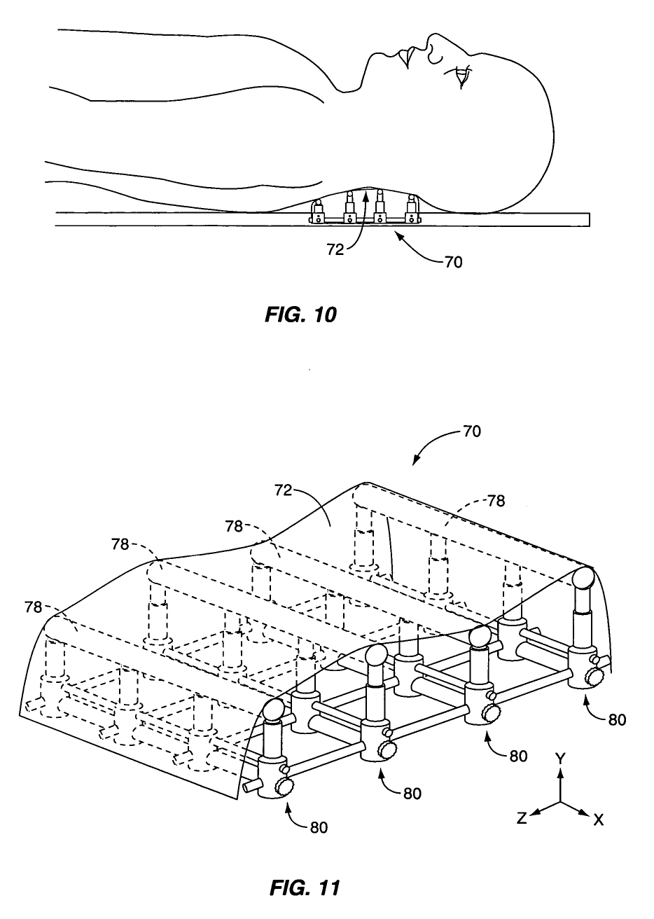

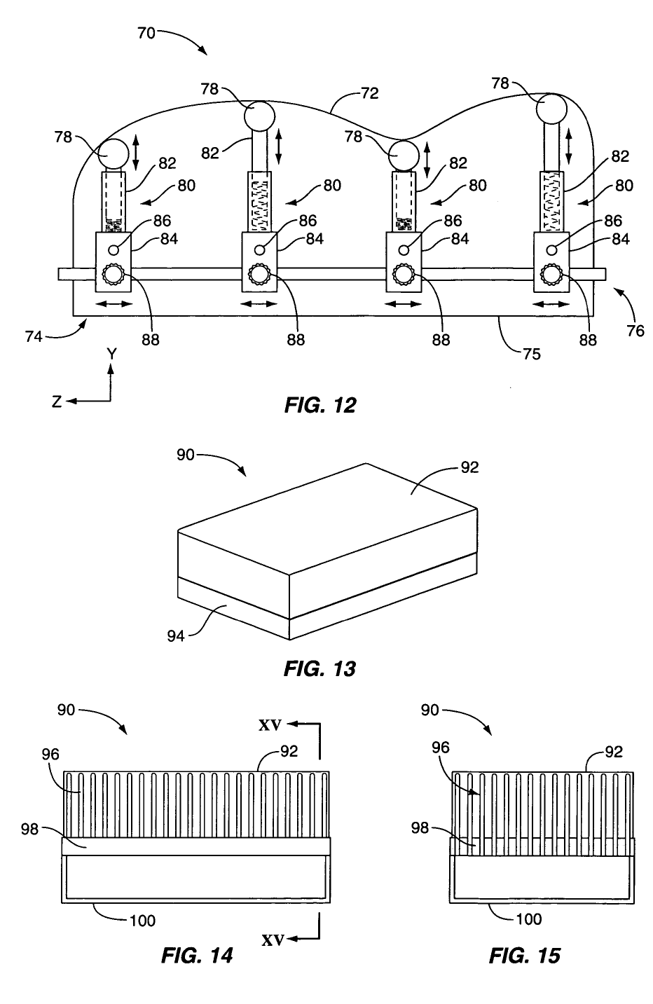

In one embodiment, the orthopedic device is designated generally by the number 70, as shown in FIGS. 10, 11, and 12. The device 70 comprises a flexible sheet 72 anchored at opposite ends 74, 76 to a base 75 (see FIG. 12 in particular). The flexible sheet 72 covers a plurality of laterally extending rollers 78, each of which are supported by independent adjustment mechanisms 80. Thus, as shown by the Cartesian coordinate system labeled X-Y-Z in FIG. 11, each of the rollers 78 is independently adjustable in either the Y-direction or the Z-direction. In general, the rollers extend substantially in the X-direction parallel to the base 75, which resides substantially in the X-Z plane. The flexible sheet 72 is comprised of a pliable material that is thick enough to supportably follow the contours of the rollers 78 beneath the flexible sheet 72 as well as the contours of a patient's anatomy above the flexible sheet 72. Plastic or polymer materials may be suitable for such a purpose.

The individual adjustment mechanisms 80 include extending or telescoping support members 82 that move the rollers 78 in the Y-direction. The support members 82 extend between the rollers 78 and a base member 84. The support members 82 may be threaded, pneumatic, or spring biased to impart motion to the rollers 82 in the Y-direction. The position of each individual roller 82 in the Y-direction is set by manipulating an actuator 86 that serves to control the appropriate translation mechanism (e.g., threads, air pressure, spring-bias lock, etc. . . . ). Similarly, the position of each adjustment mechanism 80 in the Z-direction is set by manipulating an actuator 88 that serves to control that appropriate translation mechanism, which may also comprise pneumatic, spring biased, or threaded mechanisms. The actuators 86, 88 may inherently function as locking members, but dedicated locking mechanisms (not shown) may be appropriate and perhaps even desirable for added stability. Appropriate locking mechanisms will vary according to the translation mechanism implemented and are known by those skilled in the art. Some non-limiting examples include friction locks, gear locks, pins, clamps, seals (in the case of pneumatic devices), and the like.

In practice, this device 70 may be mounted to a wall or mounted or laid to rest on a table. The subject anatomy is then brought into contact with the flexible sheet 72 and the actuators 86, 88 are then manipulated to adjust the position of the individual rollers 78, and consequently the flexible sheet 72, to closely match the anatomy. Alternatively, the rollers 78 may be adjusted to impart a desired position different than the existing neutral position for the subject anatomy.

### Embodiment 6

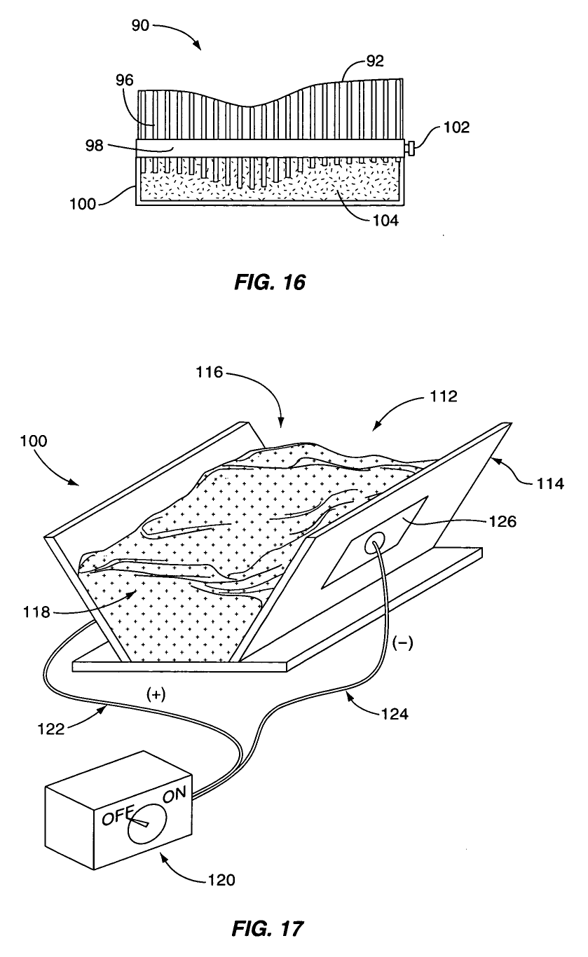

In one embodiment, the orthopedic device is designated generally by the number 90, as shown in FIGS. 13,14,15, and 16. The device 90 resembles a pillow and comprises a flexible sheet 92 that covers an array of blunted or rounded pins 96. Initially, the pins 96 are held in place in an extended first position by a perforated base 98, as shown in FIGS. 14 and 15. However, each pin 96 is moveable or retractable through the perforated base 98 into a second position in the suspension base 100 (see FIG. 16). The suspension base 100 provides space into which the pins 96 may retract under the influence of pressure applied to the flexible sheet 92. The fit between the individual pins 96 and the perforated base 98 is advantageously sufficiently tight to allow the pins 96 to move, but simultaneously offers enough resistance to require a pressure to move the pins 96.

A dedicated locking mechanism may be employed (as shown in FIG. 16) to secure the pins in their relative positions. In one embodiment, the locking mechanism is a magnetic brake or other suitable lock, such as a friction lock or clamp that is activated by an actuator 102. Alternatively, the suspension base 100 may be filled with a curable liquid 104 such as a quick-set epoxy or light-curable liquid to maintain the position of the pins 96. Where a dedicated locking mechanism is used, it may be desirable to bias the individual pins 96 toward the flexible sheet 92 to facilitate the registration process. Thus, as a patient settles the target anatomy into the desired position against the device 90, the pins 96 are pushed against the anatomy even after unintentional inward deflections of the pins 96.

As with other embodiments described above, the orthopedic device 90 may be used to capture or register a desired anatomical position. The patient (standing or lying) is brought into contact with the device 90 with the desired anatomy in the desired position. The desired position may be a natural or neutral position or a target position. As the patient contacts the device 90, the pins 96 retract into the suspension base 100. Then, once the pins are secured in position with the appropriate locking mechanism (e.g., actuator 102, curing material 104), the patient may simply lift the desired anatomy off the device 90. At this point, the flexible sheet 92, which follows the contour formed by the top of the pins 92, forms a negative of the desired anatomical position. In one embodiment, the pins directly contact the patient and there is no flexible sheet 92.

### Embodiment 7

In one embodiment, the orthopedic device is designated generally by the number 110, as shown in FIG. 17. The device 110 comprises a flexible, compliant bladder 112 filled with a Magneto-Rheological (MR) Fluid 118, which is a suspension of micron-sized, magnetizable particles in a carrier fluid. Normally, MR fluids are free-flowing liquids having a consistency similar to that of motor oil. However, when a magnetic field is applied, their rheology changes to a consistency similar to putty. MR fluids having properties suitable for this application are available from Lord Corporation in Cary, N. C. The bladder 112 is contained within a frame 114, which advantageously holds the bladder 112 in place while providing an opening 116 into which the desired anatomy may be positioned. Clearly, different frame 114 and bladder 112 configurations may be used for different anatomy parts, adults, children, and so on.

The device 110 further comprises a control box 120 from which positive (+) 122 and negative (−) 124 leads are electrically coupled to magnetizing terminals 126 positioned on the frame 114. The controlling function may also be implemented in a controller (not shown) implemented directly on or attached to the frame 114. The magnetizing terminals 126 may comprise plates that are opposed to one another so that the presence of an energy source provided by the control box 120 via the leads 122,124 creates a magnetic field between the terminals 126. The resulting magnetic field is advantageously strong enough to cause the MR fluid 118 to solidify in its present shape.

In practice, the desired anatomy is placed in the desired position on or against the bladder 112 and the uncharged MR fluid 118 flows to conform to the desired anatomy. Once the appropriate position is achieved, the control box 120 is activated to impart a magnetic field on the MR fluid 118 to retain the desired shape. Rechargeable battery sources (not shown) may be coupled to the control box 120 (and hence, the magnetic terminals 126) to retain the desired shape for an extended period of time at least until the desired contour is no longer needed. Furthermore, the use of rechargeable batteries enhance the portability of the overall device 110.

In each of the above embodiments, suitable materials for the orthopedic devices 10, 40, 50, 65, 70, 90, and 100 may include aluminum, plastic resin, or some other radiolucent materials. Alternatively, to create a distinctively different object during imaging processes, radio-opaque materials may be used to distinguish the subject anatomy.

The present invention may be carried out in other specific ways than those herein set forth without departing from the scope and essential characteristics of the invention. For example, while the various embodiments have been described as discrete entities, the characteristics of each embodiment may be combined to form even more embodiments. For instance, the MR fluid may also be suitably implemented in the multi-chamber devices discussed above. The present embodiments are, therefore, to be considered in all respects as illustrative and not restrictive, and all changes coming within the meaning and equivalency range of the appended claims are intended to be embraced therein.

What is claimed is:

1. A method of registering a skeletal position of a vertebral section, the method comprising:
placing a contact surface of an orthopedic device in contact with the vertebral section;
adjusting a shape of the contact surface to conform to the skeletal position of the vertebral section; and
locking the shape of the contact surface such that it remains after the vertebral section is removed from the contact surface.

2. The method of claim 1 wherein adjusting the shape of the contact surface comprises independently inflating one or more chambers of a multi-chamber orthopedic device with a filler substance.

3. The method of claim 1 wherein adjusting the shape of the contact surface comprises changing the curvature of a flexible sheet by altering a distance between two ends of the flexible sheet.

4. The method of claim 1 wherein adjusting the shape of the contact surface comprises deflecting an array of pins from between an extended position to a retracted position by applying pressure to the contact surface with the vertebral section.

5. The method of claim 1 wherein adjusting the shape of the contact surface comprises adjusting a position of a plurality of rollers substantially aligned in a parallel alignment.

6. The method of claim 5 comprising adjusting the position of the plurality of rollers in a direction substantially normal to the parallel direction.

7. The method of claim 5 comprising adjusting the position of the plurality of rollers in a plane substantially normal to the parallel direction.

8. The method of claim 1 wherein locking the contact surface comprises applying a magnetic field to a magneto-rheological fluid contained within the contact surface thereby changing the rheology of the fluid to a consistency adapted to retain the skeletal position.

9. The method of claim 1 further comprising determining a position of a datum reference feature operatively coupled to the orthopedic device.

10. A method of re-creating an anatomical position of a vertebral section, the method comprising:
placing a flexible contour surface of an orthopedic device in contact with the vertebral section for which said anatomical position is to be registered;
adjusting a plurality of support members and conforming the contour surface to replicate the anatomical position;
locking the contour surface in the anatomical position;
removing the orthopedic device from the vertebral section; and
thereafter, placing the vertebral section in contact with the locked contour surface and re-creating the anatomical position.

11. The method of claim 10 wherein locking the contour surface is performed preoperatively and mating the body part to the contour surface is performed interoperatively.

12. The method of claim 10 wherein conforming the contour surface replicates a head and neck region of the vertebral section.

13. The method of claim 10 wherein adjusting the shape of the contour surface comprises deflecting an array of pins from between an extended position to a retracted position by applying pressure to the contour surface with the vertebral section.

14. The method of claim 10 wherein adjusting the shape of the contour surface comprises adjusting a position of a plurality of rollers substantially aligned in a parallel direction.

15. The method of claim 14 comprising adjusting the position of the plurality of rollers in a direction substantially normal to the parallel direction.

16. The method of claim 14 comprising adjusting the position of the plurality of rollers in a plane substantially normal to the parallel direction.

17. The method of claim 10 wherein locking the contour surface is performed in a physician's office and mating the body part to the contour surface is performed in an imaging lab.

18. The method of claim 10 further comprising determining a position of a datum reference feature operatively coupled to the orthopedic device and reestablishing the desired anatomical position of a body part after mating the body part to the contact surface at some later time by replicating the position of the datum reference feature.

19. A method of repeatably establishing a desired anatomical position of a body part comprising:
enclosing a magneto-rheological fluid within the bladder;
placing an outer surface of the flexible bladder in contact with said body part;
allowing the outer surface of the flexible bladder and magneto-rheological fluid to conform to the desired body part; and
applying a magnetic field to the magneto-rheological fluid and retaining the desired anatomical position.

20. The method of claim 19 further comprising actuating a controller to apply the magnetic field.

21. The method of claim 19 further comprising applying and maintaining the magnetic field using a portable power source.

22. The method of claim 21 wherein the portable power source comprises a rechargeable battery.

23. A device to capture a skeletal position of adjacent vertebral members, the device comprising:
one or more independently deformable members forming a contact area adapted to contact the adjacent vertebral members and a finite area around the vertebral members;
an adjustment member operatively connected to the one or more independently deformable members to selectively support the deformable members to position the contact area against the vertebral members to replicate the skeletal position; and
a locking mechanism to lock the one or more deformable members to maintain the shape of the contact area in the skeletal position after the vertebral members are removed from the contact area.

24. The device of claim 23 wherein the deformable member is a flexible sheet.

25. The device of claim 24 wherein one end of the flexible sheet is operatively coupled to an adjustment member, the adjustment member moveable to change the shape of the flexible sheet.

26. The device of claim 24 wherein two opposite ends of the flexible sheet are operatively coupled to an adjustment member to change the shape of the flexible sheet.

27. The device of claim 24 wherein the adjustment member comprises rollers extending in a widthwise direction of the flexible sheet, the rollers being adjustable in a direction normal to the widthwise direction.

28. The device of claim 27 wherein the rollers are adjustable in a plane normal to the widthwise direction.

29. The device of claim 24 wherein the adjustment member comprises pins extending outwardly in a first position, the pins being inwardly retractable from the first position to a second position, the flexible sheet being operatively connected to the pins to conform to the position of the pins.

30. The device of claim 23 wherein the adjustment member comprises a magneto-rheological substance that flows to conform to the desired skeletal position when the magneto-rheological substance is in the absence of a magnetic field and retains the desired skeletal position when the magneto-rheological substance is in the presence of a magnetic field.

31. The device of claim 23 wherein the locking mechanism is operatively connected to the adjustment member to lock the adjustment member to maintain the shape of the contact area after the vertebral members are removed from the contact area.

32. The device of claim 23 further comprising a datum reference feature.

33. A device to capture an anatomical position of a body, the device comprising:
a base;
one or more support members attached to the base and movable between extended and retracted positions relative to the base;
an adjustment member operatively connected to the one or more support members to position the support member against said body; and
a locking mechanism to lock the one or more support members.

34. The device of claim 33 wherein the support members comprise rollers extending in a direction substantially parallel to the base, the rollers being adjustable between the extended and retracted positions in a direction substantially normal to the base.

35. The device of claim 34 wherein the rollers are hydraulically adjustable in the direction substantially normal to the base.

36. The device of claim 34 wherein the rollers are pneumatically adjustable in the direction substantially normal to the base.

37. The device of claim 34 wherein the rollers are mechanically adjustable in the direction substantially normal to the base.

38. The device of claim 34 wherein the rollers are adjustable in a plane substantially normal to the base.

39. The device of claim 34 wherein the support members comprise pins extending outwardly in a direction substantially normal to the base, the pins being retractable from the extended position to the retracted position along the direction substantially normal to the base.

40. The device of claim 33 wherein the locking mechanism comprises a mechanical lock.

41. The device of claim 33 wherein the locking mechanism comprises a curable substance.

42. The device of claim 33 further comprising a datum reference feature.

43. A device to capture an anatomical shape of a body, the device comprising:
a flexible cover; and
a magneto-rheological fluid supporting the outer cover, the magneto-rheological fluid and the cover being deformable to conform to said anatomical shape when the cover is in contact with the body and the magneto-rheological fluid is outside the presence of a magnetic field, and the magneto-rheological fluid and the outer cover retaining said anatomical shape when the magneto-rheological fluid is in the presence of the magnetic field and no longer in contact with the body.

44. The device of claim 43 further comprising a controller for selectively generating a magnetic field through the magneto-rheological fluid.

45. The device of claim 44 further comprising a power source and circuitry to generate the magnetic field through the magneto-rheological fluid via the controller.

46. The device of claim 45 wherein the power source comprises a rechargeable power source.

47. A device to capture a skeletal position of a body, the device comprising:
a plurality of independently inflatable chambers connected together to form a contact area adapted to contact the body;
at least one of the independently inflatable chambers being an intermediate chamber having a segment supported at opposite ends as to create open areas adjacent either side of the suspended segment;
the independently inflatable chambers being fillable with varying amounts of a filler substance to conform the contact area to said skeletal position, the inflatable chambers maintaining the conformed shape of the skeletal position after the body is removed from the contact area.

48. The device of claim 47 wherein the plurality of independently inflatable chambers comprise two end chambers and one intermediate chamber.

49. The device of claim 47 wherein the independently inflatable chambers are sealable to contain a gas.

50. The device of claim 49 further comprising an air pressure regulating system comprising control valves for controlling the flow of gas to and from each of the chambers.

51. The device of claim 49 further comprising an air coupling for connection to a compressed gas source.

52. The device of claim 47 wherein the filler substance is a thermoplastic material.

53. The device of claim 47 wherein the filler substance is a curable liquid.

54. A device to capture an anatomical shape of a vertebral section of a body, the device comprising:
a base;
a flexible sheet having first and second ends, the first end being attached to the base; and
an adjustment member operatively connected to the base and to the second end of the flexible member, the adjustment member moveable along the base to adjust the distance between the first and second ends of the flexible sheet to adjust an overall shape of the flexible sheet to conform to the vertebral shape of the body.

55. The device of claim 54 further comprising a second adjustment member operatively connected to the base and to the first end of the flexible member, the second adjustment member moveable along the base to adjust the distance between the first and second ends of the flexible sheet and change the overall shape of the flexible sheet to conform to the vertebral shape of the body.

56. The device of claim 54 wherein the flexible member is a bendable sheet having a thickness substantially less than a width and a length.

57. The device of claim 54 wherein the base comprises a rack having a plurality of teeth and the adjustment member comprises a pinion gear operatively mounted to the rack to move along the plurality of teeth.

58. The device of claim 54 further comprising a fastener to attach the first end of the flexible sheet to the base.

59. The device of claim 54 further comprising a bearing to movably mount the device to a surface.

60. A device to capture an anatomical shape of a vertebral section, the device comprising:
a base having a length;
a flexible sheet; and
a plurality of contact members operatively connected to the base and having a contact portion in contact with the flexible member, the contact members being laterally movable along the length of the base and the contact portion being vertically adjustable from the base to conform the flexible sheet to the anatomical shape.

61. The device of claim 60 wherein each contact member further comprises a pneumatic adjustment to vertically adjust the contact portion relative to the base.

62. The device of claim 61 wherein the contact members are adjustable in a plane substantially normal to the base.

63. The device of claim 60 wherein each of the plurality of contact members is substantially linear and extends from a first side to a second side of the base.

64. The device of claim 63 wherein the plurality of contact members are arranged in a parallel configuration along the flexible sheet.

65. The device of claim 64, wherein the plurality of contact members are evenly spaced along the flexible sheet.

66. The device of claim 60 wherein each of the plurality of contact members has a vertical lock to lock the vertical position of the contact portion relative to the base.

67. The device of claim 60 wherein each of the plurality of contact members has a horizontal lock to lock the horizontal position of the contact portion relative to the base.

68. A device to capture an anatomical shape of a vertebral section, the device comprising:
a support member;
a plurality of pins movably positioned within the support member, each of the pins movable between a first extended position and a second retracted position, the pins being movable between the first and second positions to conform to the anatomical shape when placed in contact with the vertebral section; and
a locking mechanism operatively connected to the plurality of pins to lock the pins and maintain the anatomical shape of the vertebral section.

69. The device of claim 68 wherein each of the plurality of pins has an elongated shape with a first end extending upward from the support member to contact the vertebral section and a second end being supported by the support member.

70. The device of claim 68 wherein each of the plurality of pins is substantially straight and mounted in a parallel arrangement within the support member.

71. The device of claim 70 wherein the plurality of pins are evenly distributed about the support member.

72. The device of claim 68 further comprising a cover extending over the plurality of pins, the cover being constructed of a flexible material to conform to the anatomical shape.

73. The device of claim 68 wherein the locking mechanism comprises a curable substance to lock the pins and maintain the anatomical shape of the vertebral section.
